(19) United States
(12) Patent Application Publication
(10) Pub. No.: US 2024/0071654 A1
(43) Pub. Date: Feb. 29, 2024

(54) RESISTANCE STRUCTURE AND MANUFACTURING METHOD THEREOF

(71) Applicant: JUNEWAY ELECTRONIC TECHNOLOGY CO., LTD., Jiangmen (CN)

(72) Inventor: Xianwei JIANG, Jiangmen (CN)

(73) Assignee: JUNEWAY ELECTRONIC TECHNOLOGY CO., LTD., Jiangmen (CN)

(21) Appl. No.: 18/503,365

(22) Filed: Nov. 7, 2023

Related U.S. Application Data
(63) Continuation of application No. PCT/CN2023/108960, filed on Jul. 24, 2023.

(30) Foreign Application Priority Data
Jul. 26, 2022 (CN) 202210887582.4

(51) Int. Cl. H01C 1/14; H01C 7/00; H01C 17/28

(52) U.S. Cl. CPC H01C 1/14; H01C 7/00; H01C 17/28

(57) ABSTRACT

Disclosed are a resistance structure and a method for manufacturing the resistance structure. The resistance structure includes: a substrate; and a metal layer provided on the substrate, the metal layer includes a first metal region and a second metal region, and the first metal region is provided in a non-electrode region on the second metal region; the metal layer is provided with a first insulating layer and an electrode layer, the first insulating layer is configured to cover the non-electrode region, and the electrode layer is provided in an electrode region on the second metal region.

### CROSS-REFERENCE TO RELATED APPLICATIONS

This application is a continuation application of International Application No. PCT/CN2023/108960, filed on Jul. 24, 2023, which claims priority to Chinese Patent Application No. 202210887582.4, filed on Jul. 26, 2022. The above-mentioned applications are incorporated herein by reference in their entireties.

### TECHNICAL FIELD

The present application relates to the technical field of electronic elements, and in particular to a resistance structure and a manufacturing method thereof.

### BACKGROUND

With the rapid development of science and technology, various devices are becoming increasingly miniaturized and portable. Correspondingly, the size of the electronic elements of the various devices is getting smaller and smaller, which is also the current development trend. For the resistive elements, the resistance value of the resistive elements. can be adjusted by changing the resistance area, the length, the material, etc., or changing the overall volume of the resistive elements.

In the application process of the resistive elements, there is usually a certain relationship between the size information, such as the thickness and the area of the resistance, and the resistance value of the resistance. In some application structures, when the resistance value is determined, the resistive element with the corresponding resistance value may not be used normally due to size factors such as the area and thickness of the resistance, resulting in inaccurate voltage or current.

The above content is only used to assist in understanding the technical solution of the present application, and does not mean that the above content is admitted as the related art.

### SUMMARY

The main purpose of the present application is to provide a resistance structure and a manufacturing method thereof, aiming at solving the technical problem of how to reduce the thickness of the resistive element in the related art while the resistance value remains unchanged.

In order to achieve the above purpose, the present application provides a resistance structure, including:
a substrate; and
a metal layer provided on the substrate, the metal layer includes a first metal region and a second metal region, and the first metal region is provided in a non-electrode region on the second metal region;
the metal layer is provided with a first insulating layer and an electrode layer, the first insulating layer is configured to cover the non-electrode region, and the electrode layer is provided in an electrode region on the second metal region.

In an embodiment, the electrode layer includes a first racking plating metal layer and a second racking plating metal layer;
the electrode region includes a first electrode region and a second electrode region respectively provided at two ends of an upper surface of the second metal region; and
the first racking plating metal layer is provided in the first electrode region, and the second racking plating metal layer is provided in the second electrode region.

In an embodiment, a thickness of the electrode layer is greater than a sum of a thickness of the first metal region and a thickness of the first insulating layer.

In an embodiment, the first racking plating metal layer and the second racking plating metal layer both include:
a copper layer with a first preset thickness;
a nickel layer with a second preset thickness provided on the copper layer; and
a tin layer with a third preset thickness provided on the nickel layer.

In an embodiment, the resistance structure further includes a contact layer provided on the substrate, and the metal layer is provided on the contact layer.

In an embodiment, a second insulating layer is provided on the first insulating layer.

In an embodiment, the first insulating layer and the second insulating layer are made of an organic material, an inorganic material, or a combined material of the organic material and the inorganic material.

In an embodiment, a sum of the thicknesses of the first metal region, the first insulating layer and the second insulating layer is less than or equal to a thickness of the electrode layer.

The present application also provides a method for manufacturing the resistance structure, including:
obtaining a substrate;
arranging a metal layer on the substrate, and etching the metal layer to obtain a convex metal layer;
arranging a first insulating layer on a non-electrode region of the convex metal layer; and
racking and plating an electrode layer in an electrode region of the convex metal layer.

In an embodiment, after the racking and plating the electrode layer in the electrode region of the convex metal layer, further including:
testing a current resistance value of the resistance structure through the racking plating electrode layer;
in response to that the current resistance value does not meet a requirement of a preset resistance value, adjusting the metal layer; and
arranging a second insulating layer on the adjusted metal layer.

The present application provides a resistance structure and a manufacturing method thereof. The resistance structure includes: a substrate and a metal layer provided on the substrate. The metal layer includes a first metal region and a second metal region, and the first metal region is provided in the non-electrode region on the second metal region. The metal layer is provided with a first insulating layer and an electrode layer, the first insulating layer covers the non-electrode region, and the electrode layer is provided in the electrode region on the second metal region. In the present application, the metal layer is provided as the first metal region and the second metal region, and the first metal region is provided in the non-electrode region on the second metal region, thereby reducing the thickness of two ends of the metal layer. The electrode layer is provided at two ends of the metal layer, so as to reduce the overall thickness of the resistance structure of the resistive element while not changing the resistance value of the resistive element.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural view of a resistance structure according to an embodiment of the present application.

FIG. 2 is a schematic structural view of a resistance structure according to an embodiment of the present application.

FIG. 3 is a top view of the resistance structure according to an embodiment of the present application.

FIG. 4 is a schematic structural view of a resistance structure according to an embodiment of the present application.

FIG. 5 is a top view of the resistance structure according to an embodiment of the present application.

FIG. 6 is a schematic flowchart of a method for manufacturing the resistance structure according to an embodiment of the present application.

FIG. 7 is a schematic flowchart of a method for manufacturing the resistance structure according to an embodiment of the present application.

The realization of the objective, functional characteristics, and advantages of the present application are further described with reference to the accompanying drawings.

### DETAILED DESCRIPTION OF THE EMBODIMENTS

It should be understood that the embodiments described here are only intended to explain and are not intended to limit the present application.

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that all directional indications (such as up, down, left, right, front, back, etc.) in the embodiments of the present application are only used to explain the relative positional relationship, the movement situation, etc. among various assemblies under a certain posture as shown in the drawings. If the specific posture changes, the directional indication also changes accordingly.

In addition, the descriptions of “first”, “second”, etc. In the present application are only for the purpose of description, and should not be construed as indicating or implying relative importance or implicitly indicates the number of technical features indicated. Thus, a feature delimited with “first”, “second” may expressly or implicitly include at least one of that feature. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in this application.

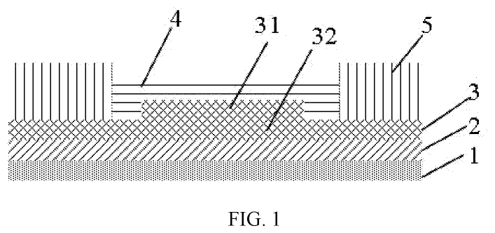

Referring to FIG. 1, FIG. 1 is a schematic structural view of a resistance structure according to an embodiment of the present application.

In an embodiment, based on FIG. 1, the present application provides a resistance structure including: a substrate 1 and a metal layer 3.

The metal layer 3 is provided on the substrate 1 and includes a first metal region 31 and a second metal region 32, and the first metal region 31 is provided in the non-electrode region on the second metal region 32.

The metal layer is provided with a first insulating layer 4 and an electrode layer 5, the first insulating layer 4 covers the non-electrode region, and the electrode layer 5 is provided in the electrode region on the second metal region 32.

It should be understood that the substrate 1 is configured for supporting a bottom of the entire resistance structure. The substrate 1 can be made of organic materials, inorganic materials or a mixture of organic materials and inorganic materials, such as ceramic substrates, glass fiber substrates and the like.

The resistance structure further includes a contact layer 2 provided on the substrate 1, and the metal layer 3 is provided on the contact layer 2. The contact layer 2 can fix the metal layer 3 on the substrate 1, and the metal layer 3 cannot be directly provided on the substrate 1 without the contact layer 2. For example, when it is necessary to arrange the metal on the glass plate, a certain amount of glue can be used, which is regarded as the contact layer between the metal and the glass plate. The contact layer 2 can be made of epoxy-based or acrylic-based materials, which can make the metal layer 3 adhere better to the substrate 1.

It can be understood that the metal layer 3 is a conductive structure layer, and the specific resistance value of the resistance structure is directly related to the size and composition material of the metal layer 3. The material constituting the metal layer 3 has a certain resistivity, so that the resistance structure presents resistivity. The metal layer 3 can be made of pure metal or metal alloy, for example, pure metal materials such as copper, silver, gold, or alloys including copper, silver, manganese, gold, and other materials.

In an embodiment, the metal layer 3 can be an integral structure made of the first metal region 31 and the second metal region 32. An area of the first metal region 31 is smaller than an area of the second metal region 32. An electrode region is provided on the second metal region 32, and the electrode region is an area used for connecting electrode leads to connect the resistance structure with other elements. The electrode regions are provided at two ends of the second metal region 32. The electrode layer 5, that is, the electrode lead may be provided in the electrode region. The electrode layer 5 is for connecting the metal layer 3 with external elements. In the specific setting process, the two ends of the entire metal layer 3 can be etched to remove part of the metal at two ends, and the electrode layer 5 is provided in the corresponding electrode region on second metal region 32 which is etched to remove a certain part of metal. The electrode layer 5 can be provided in the electrode region by racking and plating. The electrode layer 5 may be made of pure metal material or alloy material, and the composition material of the electrode layer 5 may be the same as that of the metal layer 3. In addition, in this embodiment, a plurality of electrode layers can also be provided in the electrode region of the metal layer 3, for example, two electrode layers are provided at one end of the metal layer 3 to form a four-electrode structure.

In addition, the second metal region 32 further includes a non-electrode region, and the first metal region 31 is provided in the non-electrode region. There is a certain distance between the first metal region 31 in the non-electrode region and the electrode layer in the electrode region, and there is no contact between the two. The first metal region 31 and the second metal region 32 form a metal layer 3 with a convex structure.

It should be noted that, in order to prevent the oxidation and passivation of the structure of the metal layer 3 caused by processes such as oxidizing gas and nitriding gas in the external environment, resulting in changes in the resistance value of the resistance structure, it is also necessary to arrange the first insulating layer 4 on an upper surface of the first metal region 31 and the non-electrode region on the second metal region 32. The first insulating layer 4 can effectively isolate the metal layer 3 from the external environment, thereby preventing the metal layer 3 from being affected by the external environment and protecting the metal layer 3. The first insulating layer 4 may be made of organic material, inorganic material or a mixed material of organic material and inorganic material. The organic material may be solder resist ink, and the inorganic material may be silicon dioxide, gallium nitride, aluminum nitride, etc., and the mixed material can be an organic material and an inorganic material provided in layers, for example, a layer of silicon dioxide is provided on the solder resist ink, or a layer of solder resist ink is provided on the silicon dioxide.

The present application provides a resistance structure, including: a substrate 1 and a metal layer 3 provided on the substrate 1. The metal layer 3 includes a first metal region 31 and a second metal region 32, and the first metal region 31 is provided in the non-electrode region on the second metal region 32. The metal layer 3 is provided with a first insulating layer 4 and an electrode layer, the first insulating layer 4 covers the non-electrode region, and the electrode layer is provided in the electrode region on the second metal region 32. In the present application, the metal layer 3 is provided as the first metal region 31 and the second metal region 32, and the first metal region 31 is provided in the non-electrode region on the second metal region 32, thereby reducing the thickness of two ends of the metal layer 3. The electrode layer is provided at two ends of the metal layer 3, so as to reduce the overall thickness of the resistance structure of the resistive element while not changing the resistance value of the resistive element.

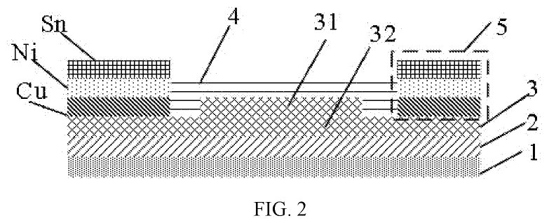

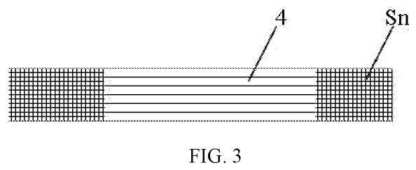

Referring to FIG. 2 and FIG. 3, FIG. 2 is a schematic structural view of a resistance structure according to an embodiment of the present application. FIG. 3 is a top view of the resistance structure according to an embodiment of the present application.

In an embodiment, the electrode layer 5 includes: a first racking plating metal layer and a second racking plating metal layer;
the electrode region 5 includes a first electrode region and a second electrode region respectively provided on two ends of the upper surface of the second metal region 32;
the first racking plating metal layer is provided in the first electrode region, and the second racking plating metal layer is provided in the second electrode region.

It should be understood that, during the setting process of the resistance structure, two electrode leads can connect the two ends of the resistance with external devices. Therefore, when rack-plating the electrode layer 5, two racking plating metal layers need to be provided, that is, the electrode layer includes two racking plating metal layers. The racking plating metal layer is provided in the electrode region of the second metal region 32 through racking-plating. The racking plating metal layer can be connected to other elements through wires. Similarly, the second metal region 32 also includes two electrode regions, i.e., the first electrode region and the second electrode region, and the racking plating metal layer can be plated in the first electrode region and the second electrode region.

The first electrode region and the second electrode region are respectively provided at the two ends of the second metal region 32, and there is a certain gap between the first electrode region, the second electrode region and the first metal region 31, which can avoid the electrode layer 5 in the electrode region contact with the first metal region 31, and can also collect the resistivity of the entire metal layer 3 to avoid false detection of the resistance value of the resistance structure. The resistance value collected through the electrode layer 5 is the resistance value on the metal layer 3 between the two electrode layers. When the electrode layer 5 is not at the two ends of the metal layer 3, the detected resistance value is not the actual resistance value of the entire metal layer 3.

In addition, in this embodiment, the thickness of the electrode layer 5 is greater than or equal to the thickness of the first metal region 31 and the first insulating layer 4.

It should be understood that, during the setting process of the resistance structure, the electrode layer 5 needs to be drawn out, so as to establish a connection between the resistance structure and other elements. Therefore, the thickness of the electrode layer 5 provided on the second metal region 32 should be greater than or equal to the sum of the thicknesses of the first metal region 31 and the first insulating layer 4, so that the electrode layer 5 protrudes from the resistance structure.

In this embodiment, the first racking plating metal layer and the second racking plating metal layer both include: a copper (Cu) layer with a first preset thickness, a nickel (Ni) layer with a second preset thickness provided on the Cu layer, and a tin (Sn) layer with a third preset thickness provided on the Ni layer.

It should be understood that, since the copper has a good electrical conductivity, when the current passing through the metal layer 3 is drawn out, a thicker Cu layer can be provided. The first preset thickness is a preset thickness of the Cu layer, and the thickness of the Cu layer may be the same as the thickness of the first metal region 31. The Sn layer is a material layer provided on the uppermost layer of the racking plating metal layer. Since the tin material has a certain oxidation resistance, the Sn layer is directly exposed to the external environment, and the external environment will not affect the structure of the racking plating metal layer. The third preset thickness is the preset thickness of the Sn layer. In the specific setting, the thickness of the Sn layer only needs to meet the requirements of wear, so that the third preset thickness of the Sn layer can be far smaller than the first preset thickness of the Cu layer.

It should be noted that, in this embodiment, the Sn layer can also be directly provided on the Cu layer. As materials, tin is quite different from copper, thus the adhesion between the two is poor, which may cause an inaccurate detection of the resistance value of the structure, and will also lead to the problem of the power coefficient of the resistance. Therefore, in practical applications, the Ni layer can be provided between the Cu layer and the Sn layer, which can better bond the Cu layer and the Sn layer together, and can also avoid the metal problem of the power coefficient of the resistance in the racking plating.

It can be understood that the second preset thickness is the preset thickness of the Ni layer, because the Ni layer is to make the better adhesion between the Cu layer and the Sn layer, there is no need to set a very thick Ni layer, thus the second preset thickness of the Ni layer may be smaller than the third preset thickness of the Sn layer. For example, the thickness of the Cu layer and the first metal region 31 can both be set to 80 microns, while the thickness of the Ni layer is 5 microns, and the thickness of the Sn layer is 10 microns.

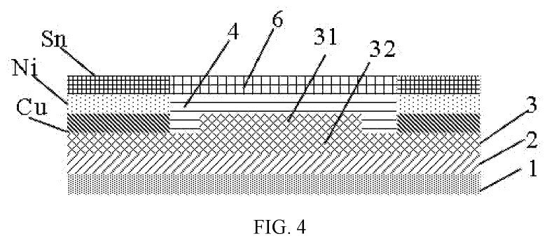

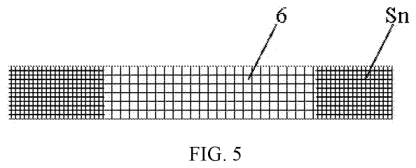

Referring to FIG. 4 and FIG. 5, FIG. 4 is a schematic structural view of a resistance structure according to an embodiment of the present application. FIG. 5 is a top view of the resistance structure according to an embodiment of the present application.

In this embodiment, a second insulating layer 6 is further provided on the first insulating layer 4.

It should be understood that after the setting of the resistance structure is completed, the specific resistance value of the resistance structure needs to be detected. During the detection process, the process of adjusting the metal layer 3 in the resistance structure may be involved. For example, in the etching process of the metal layer 3, there is a certain under-etching or over-etching, resulting in a certain difference between the resistance value of the resistance structure and the actual required resistance value, thus the metal layer 3 needs to be adjusted, so as to meet the requirement of the resistance value of the resistance structure.

It should be noted that when adjusting the resistance value, usually the structure of the first metal region 31 can be directly and slightly adjusted, but since the first insulating layer 4 is provided on the first metal region 31, when the first metal region 31 is adjusted, the structure of the first insulating layer 4 will be damaged. After the resistance value adjustment of the resistance structure is completed, in order to prevent the first metal region 31 from being partially exposed to the external environment, the second insulating layer 6 can also be provided on the first insulating layer 4, thereby effectively preventing the first metal region 31 from being partially exposed to the external environment.

It can be understood that the structure and composition of the second insulating layer 6 can be the same as that of the first insulating layer 4, and can also be different, as long as the second insulating layer 6 can prevent the first electrode region 31 on the metal layer 3 from being destroyed by oxidizing, nitriding and other processes from the external environment. Of course, in the actual installation process, the first insulating layer 4 and the second insulating layer 6 can also be made of solder resist ink.

In this embodiment, in order to further reduce the thickness of the resistance structure, the sum of the thicknesses of the first metal region 31, the first insulating layer 4, and the second insulating layer 6 can be set to be equal to the thickness of the electrode layer 5.

It can be understood that, in the manufacturing process of the resistance structure, the electrode layer 5, the first metal region 31, the first insulating layer 4 and the second insulating layer 6 are necessary structures. The electrode layer 5 is provided in the electrode region on the second metal region 32, and the first metal region 31, the first insulating layer 4 and the second insulating layer 6 are sequentially provided in the non-electrode region of the second metal region 32. The sum of the thicknesses of the first metal region 31, the first insulating layer 4, and the second insulating layer 6 is set to be the same as the thickness of the electrode layer 5, which can reduce the thickness of the resistance structure while improving the other properties of the resistance structure. For example, when the thickness of the electrode layer 5 is greater than the sum of the thicknesses of the first metal region 31, the first insulating layer 4, and the second insulating layer 6, the thickness of the first insulating layer 4 or the second insulating layer 6 can be increased, so that the protection to the metal layer 3 is further strengthened while not changing the overall thickness of the resistance structure. When the thickness of the electrode layer 5 is less than the sum of the thicknesses of the first metal region 31, the first insulating layer 4 and the second insulating layer 6, the thickness of the Cu layer in the electrode layer 5 can be properly adjusted to increase the stability of measuring the resistance structure. Referring to FIG. 4, in FIG. 4, the thickness of the second metal region 32 can be 120 microns, the thickness of the first metal region 31 can be 80 microns, the thickness of Cu layer can be 80 microns, the thickness of Ni layer can be 5 microns, the thickness of the Sn layer can be 10 microns, the thickness of the first insulating layer 4 provided on the first metal region 31 can be set to Sum, and a maximum thickness of the first insulating layer 4 on the second metal region 32 can be 85 microns, and the thickness of the second insulating layer 6 can be 10 microns.

In addition, in the present application, the first metal region 31 and the second metal region 32 of the metal layer 3 form the convex structure. Considering the adjustment of the resistance value of the resistance structure, the thickness of the racking plating copper layer in the electrode region can be adjusted. For example, when the thickness requirement of the resistance structure is not very high, but the resistance value of the resistance structure needs to be reduced, the thickness of the racking plating copper layer in the electrode region on the etched metal layer 3 can be adjusted. The resistivity in the overall electrode structure is reduced by increasing the thickness of the Cu layer, thereby reducing the resistance value of the resistance structure. The thickness of the Cu layer in the racking plating electrode layer 5 should be greater than the thickness of the first metal region 31. At this time, the overall thickness of the electrode layer 5 can also be greater than the sum of the first metal region 31, the first insulating layer 4 and the second insulating layer 6. Although the way of increasing the thickness of the Cu layer in the electrode region will have a certain impact on the overall thickness of the resistance structure, in the case where the thickness of the resistance structure is not strict, the resistance value of the resistance structure can be reduced.

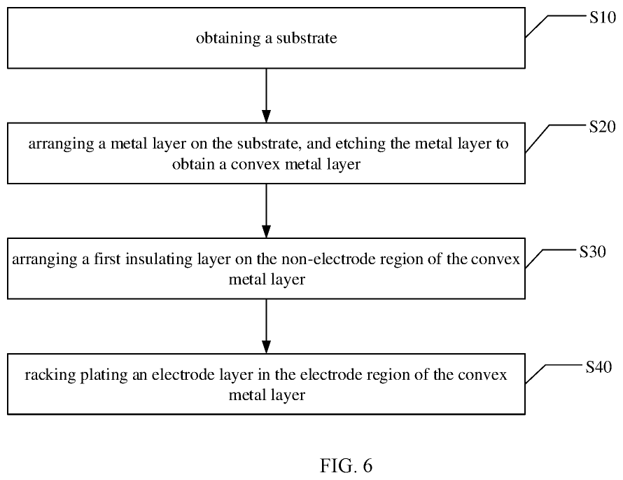

In addition, to achieve the above purpose, referring to FIG. 6, FIG. 6 is a schematic flowchart of a method for manufacturing the resistance structure according to an embodiment of the present application, and the resistance structure manufacturing method including:

S10: obtaining a substrate.

It can be understood that the substrate is for supporting the bottom the entire resistance structure. The substrate may be made of organic materials, inorganic materials or a mixture of organic and inorganic materials, such as ceramic substrates, glass fiber substrates, and the like.

It should be understood that after the substrate is set, a contact layer may also be provided on the substrate.

It should be noted that the contact layer can be used to fix the metal layer on the substrate. For example, when the metal needs to be placed on the glass plate, a certain amount of glue can be used, and the glue is regarded as the contact layer between the metal and the glass plate. The contact layer can be made of materials such as epoxy or acrylic, thus the metal layer adheres better to the substrate.

In an embodiment, considering the adhesion between the substrate and the metal layer, after the substrate is set, the connection layer may be provided on the substrate.

S20: arranging a metal layer on the substrate, and etching the metal layer to obtain a convex metal layer.

It should be understood that before the metal layer is set, it is also necessary to determine whether the contact layer is set on the substrate. In response to that the contact layer is not set, the metal layer can be directly set on the substrate; and in response to that the contact layer is already set, the metal layer needs to be provided on the contact layer.

It should be noted that the metal layer is a conductive, and the specific resistance value of the resistance structure is directly related to the size and constituent materials of the metal layer. The material making up the metal layer has a certain resistivity, so that the resistance structure is resistive. The metal layer may be made of pure metal or metal alloy, for example, the pure metal materials such as copper and silver, or alloys including copper, silver, manganese, tin and other materials.

In this embodiment, the metal layer may be an integral structure made of the first metal region and the second metal region, and the structure is a convex metal layer structure. The area of the first metal region is smaller than the area of the second metal region.

In an embodiment, the metal layer with a complete thickness can be directly set up first, then a part at the two ends with a certain area and thickness of the metal layer are respectively selected for etching. After etching the metal with the area and thickness, the convex metal layer structure made of the first metal region and the second metal region is obtained.

S30: arranging a first insulating layer on the non-electrode region of the convex metal layer.

It can be understood that in order to prevent oxidation, passivation and other effects on the structure of the metal layer caused by processes such as oxidizing gas and nitriding gas in the external environment, resulting in changes in the resistance value of the resistance structure, it is also necessary to provide the first insulating layer on the upper surface of the first metal region and the non-electrode region on the second metal region. The first insulating layer can effectively isolate the metal layer from the external environment, thereby preventing the metal layer from being affected by the external environment and thus protecting the metal layer. The first insulating layer may be made of organic materials, inorganic materials or a mixture of organic materials and inorganic materials. The organic material may be solder resist ink, and the inorganic material may be silicon dioxide, gallium nitride, aluminum nitride, etc. The mixed material can be an organic material and an inorganic material provided in a stack, for example, a layer of silicon dioxide is provided on the solder resist ink, or a layer of solder resist ink is provided on the silicon dioxide.

In an embodiment, a certain area in the second metal region can be selected as the electrode region, and a certain thickness of solder resist ink can be coated on the non-electrode region outside the electrode region as the first insulating layer.

S40: racking plating an electrode layer in the electrode region of the convex metal layer.

It should be understood that the electrode layer is a lead for connecting the metal layer with external elements. The electrode layer can be provided in the electrode region by racking plating. The electrode layer can be made of pure metal material or alloy material, and the composition material of the electrode layer can be the same as that of the metal layer. The electrode layer may include a copper layer, a nickel layer, and a tin layer.

In an embodiment, the electrode layer can be set in the electrode region on the second metal region by means of racking plating. For example, the copper layer with a first preset thickness can be racking plated on the electrode region, then the nickel layer with a second preset thickness can be racking plated on the copper layer, and finally the tin layer with a third preset thickness can be racking plated on the nickel layer to complete the process of racking plating the whole electrode layer.

It should be noted that since copper has a good electrical conductivity, when the current passing through the metal layer is drawn out, a thicker copper layer can be provided. The first preset thickness is a preset thickness of the copper layer, and the thickness of the copper layer may be the same as the thickness of the first metal region. The tin layer is a material layer provided on the uppermost layer of the racking plating metal layer. Since the tin material has a certain oxidation resistance, the tin layer is directly exposed to the external environment, and the external environment will not affect the structure of the racking plating metal layer. The third preset thickness is the preset thickness of the tin layer. In the specific setting, the thickness of the tin layer only needs to meet the needs of wear, so that the third preset thickness of the tin layer can be far smaller than that of the first preset thickness of the copper layer.

It should be noted that, in this embodiment, the tin layer can also be directly provided on the copper layer. As materials, tin is quite different from copper, thus the adhesion between the two is poor, which may cause the inaccurate detection of the resistance value. Therefore, in practical applications, the nickel layer can be provided between the copper layer and the tin layer, which can better bond the copper layer and the tin layer together. The second preset thickness is the thickness of the preset nickel layer. Since the nickel layer is to better adhere the copper layer with the tin layer, it is not necessary to provide a thicker nickel layer, so that the second preset thickness of the nickel layer can be smaller than the third preset thickness of the tin layer.

The present application provides a method for manufacturing the resistance structure, including: obtaining a substrate;
arranging a contact layer on the substrate;
arranging a metal layer on the substrate, and etching the metal layer to obtain a convex metal layer;
arranging a first insulating layer on the non-electrode region of the convex metal layer; and
racking and plating an electrode layer in the electrode region of the convex metal layer.

In this embodiment, the metal layer is set as the first metal region and the second metal region. The first metal region is provided in the non-electrode region on the second metal region, thereby reducing the thickness of two ends of the metal layer. The electrode layer is provided at two ends of the metal layer, so as to reduce the overall thickness of the resistance structure of the resistive element without changing the resistance value of the resistive element.

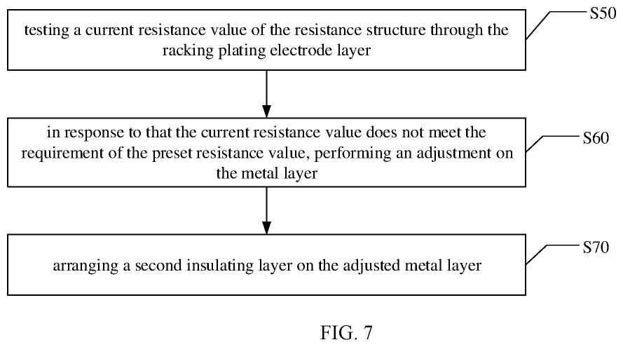

Referring to FIG. 7, FIG. 7 is a schematic flowchart of a method for manufacturing the resistance structure according to an embodiment of the present application.

In this embodiment, after S40, the method also includes:

S50: testing a current resistance value of the resistance structure through the racking plating electrode layer.

S60: in response to that the current resistance value does not meet the requirement of the preset resistance value, performing an adjustment on the metal layer.

S70: arranging a second insulating layer on the adjusted metal layer.

It should be understood that after the setting of the resistance structure, the specific resistance value of the resistance structure needs to be detected. During the detection process, the process of adjusting the metal layer in the resistance structure may be involved. For example, in the etching process of the metal layer, there is a certain under-etching or over-etching, resulting in a certain difference between the resistance value of the resistance structure and the actual required resistance value, thus the metal layer 3 needs to be adjusted to make the resistance value of the resistance structure meet the requirements.

It should be noted that, when adjusting the resistance value, usually the structure of the first metal region can be slightly and directly adjusted, but since the first insulating layer is provided on the first metal region, when adjusting the first metal region, the structure of the first insulating layer will be damaged. After the resistance value adjustment of the resistance structure is completed, in order to prevent the first metal region from being partially exposed to the external environment, the second insulating layer can also be provided on the first insulating layer, thereby effectively preventing the first metal region from being partially exposed to the external environment.

It can be understood that the structure and composition of the second insulating layer may be the same as the first insulating layer, or different, as long as it can prevent the first electrode region on the metal layer from being oxidized or nitrided by the external environment. Of course, in the actual setting process, the first insulating layer and the second insulating layer may also be made of organic material solder resist ink, inorganic material silicon dioxide and other materials.

In the specific setting process, the resistance value of the resistance structure can be detected in real time during the process of adjusting the mechanical energy of the resistance structure. When the resistance value of the resistance structure meets the preset resistance value condition, the adjustment of the resistance value will be stopped, otherwise the adjustment will continue until the resistance value of the resistance structure meets the requirement of the preset resistance value. When adjusting the resistance value of the resistance structure, it can be laser repairing, and can also be mechanical resistance repairing. For example, grinding the structure of the first metal region. When the resistance value of the resistance structure meets the requirement of the preset resistance value, it only needs to arrange the second insulating layer in the non-electrode region of the adjusted resistance structure.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

What is claimed is:

1. A resistance structure, comprising:
a substrate; and
a metal layer provided on the substrate, wherein the metal layer comprises a first metal region and a second metal region, and the first metal region is provided in a non-electrode region on the second metal region;
wherein the metal layer is provided with a first insulating layer and an electrode layer, the first insulating layer is configured to cover the non-electrode region, and the electrode layer is provided in an electrode region on the second metal region.

2. The resistance structure of claim 1, wherein:
the electrode layer comprises a first racking plating metal layer and a second racking plating metal layer;
the electrode region comprises a first electrode region and a second electrode region respectively provided at two ends of an upper surface of the second metal region; and
the first racking plating metal layer is provided in the first electrode region, and the second racking plating metal layer is provided in the second electrode region.

3. The resistance structure of claim 2, wherein a thickness of the electrode layer is greater than a sum of a thickness of the first metal region and a thickness of the first insulating layer.

4. The resistance structure of claim 3, wherein the first racking plating metal layer and the second racking plating metal layer both comprise:
a copper layer with a first preset thickness;
a nickel layer with a second preset thickness provided on the copper layer; and
a tin layer with a third preset thickness provided on the nickel layer.

5. The resistance structure of claim 4, further comprising a contact layer provided on the substrate, wherein the metal layer is provided on the contact layer.

6. The resistance structure of claim 1, wherein a second insulating layer is provided on the first insulating layer.

7. The resistance structure of claim 6, wherein the first insulating layer and the second insulating layer are made of an organic material, an inorganic material, or a combined material of the organic material and the inorganic material.

8. The resistance structure of claim 7, wherein a sum of the thicknesses of the first metal region, the first insulating layer and the second insulating layer is less than or equal to a thickness of the electrode layer.

9. A method for manufacturing the resistance structure of claim 1, comprising:
obtaining a substrate;
arranging a metal layer on the substrate, and etching the metal layer to obtain a convex metal layer;
arranging a first insulating layer on a non-electrode region of the convex metal layer; and
racking and plating an electrode layer in an electrode region of the convex metal layer.

10. The method of claim 9, after the racking and plating the electrode layer in the electrode region of the convex metal layer, further comprising:
testing a current resistance value of the resistance structure through the racking plating electrode layer;
in response to that the current resistance value does not meet a requirement of a preset resistance value, adjusting the metal layer; and
arranging a second insulating layer on the adjusted metal layer.
